(19) United States
(12) Patent Application Publication
(10) Pub. No.: US 2024/0338774 A1
(43) Pub. Date: Oct. 10, 2024

(54) Automated System for Secure, Anonymized Medical Claim Data Processing and Collateralization Management

(71) Applicants: Alexandria C. Sakrejda, Florence, MA (US); Joshua M. Holden, Santa Monica, CA (US); Susan M. Estes, Wilmington, NC (US)

(72) Inventors: Alexandria C. Sakrejda, Florence, MA (US); Joshua M. Holden, Santa Monica, CA (US); Susan M. Estes, Wilmington, NC (US)

(21) Appl. No.: 18/629,487

(22) Filed: Apr. 8, 2024

Related U.S. Application Data
(60) Provisional application No. 63/457,824, filed on Apr. 7, 2023.

(51) Int. Cl. G06Q 40/08; G06F 21/62

(52) U.S. Cl. CPC G06Q 40/08; G06F 21/6254

(57) ABSTRACT

An automated system for secure, anonymized medical claim data processing and collateralization management is provided which includes a computerized medical claims valuation and collateralization management platform. The platform receives medical claim data and medical claim remittance data, normalizes the data, matches the paid and unpaid medical claim data and medical claim remittance data, and then anonymizes the data. The anonymized data is stored in a normalized database and used to generate a predictive model applied to evaluate future medical claims. The platform then applies the predictive model to new medical claims to be used as collateral by lenders to allow automatic advancement of capital to healthcare or medical providers and automatic management of loan repayment.

### CROSS-REFERENCE TO RELATED APPLICATIONS

The present application claims the benefit of U.S. Provisional Application No. 63/457,824, filed Apr. 7, 2023, entitled “Electronic Platform for Payment Management”, which is hereby incorporated by reference in its entirety.]

### BACKGROUND OF THE INVENTION

The present invention generally relates to automated data processing systems. More particularly, the present invention relates to an automated data processing system for secure, anonymized medical claim data.

In the healthcare industry, processing of medical claim data is often a laborious and time consuming task. An additional layer of complexity and expenses is added due to the necessity for proper treatment of personally identifiable information (PII), including personal or protected health information (PHI), from inadvertent exposure.

Existing systems for evaluating and processing medical claims are often inaccurate, lack transparency, and expose the lender to the risk of PII, including PHI, exposure. Additionally, accurate accounts receivable valuation in the healthcare industry is very difficult compared to other industries.

### BRIEF SUMMARY OF THE INVENTION

One or more of the embodiments of the present invention provide an automated system for secure, anonymized medical claim data processing and collateralization management. The system includes a computerized medical claims valuation and collateralization management platform that receives medical claim data and medical claim remittance data, normalizes the data, matches the paid and unpaid medical claim data and medical claim remittance data, and then anonymizes the data. The anonymized data is stored in a normalized database and used to generate a predictive model applied to evaluate future medical claims. The platform then applies the predictive model to new medical claims to be used as collateral by lenders to allow automatic advancement of capital to healthcare or medical providers and automatic management of loan repayment.

### BRIEF DESCRIPTION OF THE DRAWINGS

FIG. 1 illustrates an automated system for secure, anonymized medical claim data processing and collateralization management according to an embodiment of the present invention.

FIG. 2 illustrates the computerized medical claims valuation and collateralization management platform determining the predictive claim valuation model according to an embodiment of the present invention.

FIG. 3 illustrates the computerized medical claims valuation and collateralization management platform applying the predictive claim valuation model to newly received claim information according to an embodiment of the present invention.

FIG. 4 illustrates the computerized medical claims valuation and collateralization management platform performing automated valuation and capital management according to an embodiment of the present invention.

FIG. 5 illustrates an exemplary EDI 837 file.

FIG. 6 illustrates the fields of an exemplary EDI 835 file.

### DETAILED DESCRIPTION OF THE INVENTION

One or more embodiments of the present invention provide an automated software platform for valuing medical claims and connecting healthcare providers to lenders. Specifically, one or more embodiments of the invention provide an automated, secure, streamlined process for evaluating the value of medical claims and connecting healthcare providers with lenders who are willing to provide cash advances against the providers' medical receivables debt.

The healthcare industry is complex and rapidly evolving, and healthcare providers face a range of financial challenges. One of the most significant challenges is access to liquidity. Healthcare providers have a significant asset in the form of medical insurance debt, but lenders are often reluctant to loan against this debt because they have no reliable way to value it. Medical claims are complex and can involve multiple parties, making it difficult for lenders to accurately assess their value. As a result, healthcare providers may struggle to obtain financing for their valuable medical claims, which may limit their ability to provide quality care to patients. One or more embodiments of the present platform address this issue by providing healthcare providers with a secure, automated, streamlined process for evaluating the value of medical claims and connecting the healthcare providers with lenders who are interested in providing financing. By providing lenders with a reliable way to value medical claims, the present platform makes it easier for healthcare providers to obtain financing and manage their finances more effectively.

As mentioned above, existing systems for evaluating medical claims are often inaccurate, lack transparency, and expose the lender to the risk of heath information exposure, such as PII, including PHI, exposure. As used herein, PII includes PHI. Thus, there is a need for a more secure, automated, streamlined and efficient system that may help healthcare providers manage their finances and thus provide better care to patients.

Also, as mentioned above, accurate accounts receivable valuation in the healthcare industry is very difficult compared to other industries. Healthcare transactions typically involve three parties: a healthcare provider, a patient, and a third-party payer, such as a government (Medicaid or Medicare) or private health insurance program or company. After the patient receives care from the provider, the provider often submits a health insurance claim to the patient's third-party payer in order to collect the covered portion of the patient's medical charges. Many factors affect the amount that the payer remits to the healthcare provider, including network contracts with the healthcare provider, the specific treatments, procedures, and diagnoses rendered, determination of medical necessity, pre-authorization requirements, referral by another provider, and patient eligibility status.

However, payers rarely pay healthcare providers the precise amount billed on the claim. This is because healthcare providers often negotiate and hold contracts with several or many separate health insurance companies, which in turn may offer many different lines, plans, or types of insurance. Each of these types and sub-types of health insurance may pay slightly different amounts for the same charge for a medical service based on the specific contract details existing between the healthcare provider and the payer. Because it is difficult and time-consuming to determine the correct amount to bill, healthcare providers will typically bill a standard amount for services rendered, meaning that the face value of the medical claim is usually larger than the realized payment amount.

Because the healthcare provider often does not know the true value of their own receivables, this presents a problem for not only the healthcare provider and their financial administration, but also their bank, their collection agents, and even the patient. Without accurate valuation of healthcare receivables, the provider's bank may not be able to provide affordable funding or advances against those receivables. Likewise, the payer may struggle to provide timely remuneration for more complex claims. Consequently, there is a need for a system that accurately values healthcare receivables and grades unpaid claims based on riskiness, repayment amount, and repayment timing.

One or more embodiments of the present system successfully address the challenges associated with characterizing medical claim predicted payment accurately and connecting healthcare providers to low-cost financing. Importantly, the system is designed to protect patients from health information and/or data exposure risk by sequestering all PII in a HIPAA-compliant computing environment.

One aspect of the present system is its ability to value medical claims and calculate their value based on a variety of factors. The system uses machine learning algorithms to compare the content of each medical claim (and/or medical claim data element) to a predictive model in order to score each medical claim based on its predictions of the probability of payment, the time-to-payment, and the payment amount.

Another aspect of the present system is the ability for lenders to set terms for loan issuance. As a result, the platform provides healthcare providers with the ability to negotiate those terms with lenders who are interested in providing financing in return for receiving later payments of medical claims. Healthcare providers can submit their valuable medical claims to the platform, and (because of data anonymization) lenders can evaluate them in a non-HIPAA compliant environment, build their own models as needed, and offer financing.

One or more embodiments of the present system also include the ability to manage the financing process. Healthcare providers can track the status of their claims and financing requests, and lenders can view their portfolios and monitor the performance of their loans and collateral coverage.

The present system represents a significant advance over existing systems for evaluating medical claims and financing them. It provides an automated, secure, streamlined and efficient solution that can help healthcare providers manage their finances and thus provide better care to patients.

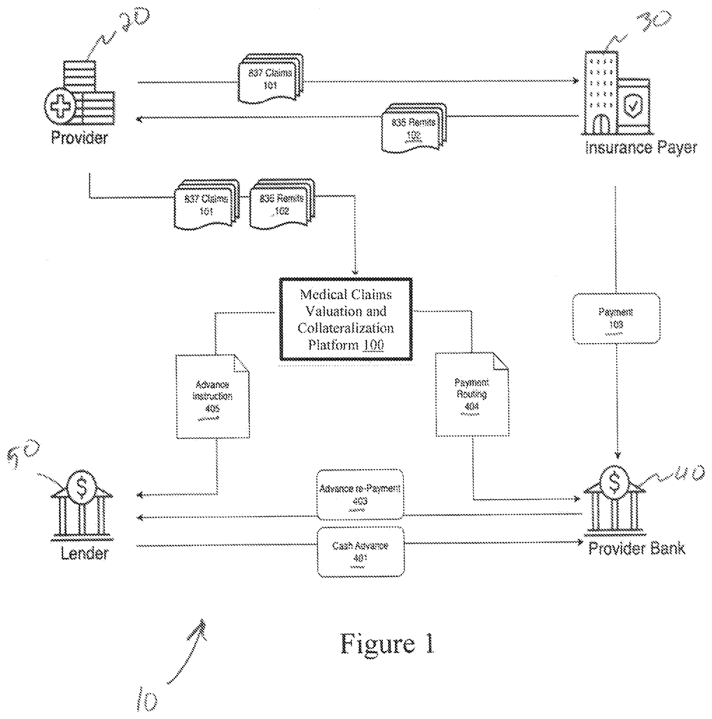

FIG. 1 illustrates an automated system for secure, anonymized medical claim data processing and collateralization management 10 according to an embodiment of the present invention. The present system 10 includes a provider computerized system 20, an insurance payer computerized system 30, a provider bank computerized system 40, a lender computerized system 50, and a computerized medical claims valuation and collateralization management platform 100.

As shown in FIG. 1, the provider computerized system 20 transmits medical claim data 101 to the insurance payer computerized system 30. In one embodiment, the medical claim data 101 may be standardized medical claim Electronic Data Interchange (EDI) 837 files. Medical claims in medical claim EDI 837 files are typically generated and submitted by providers of medical services to the entities insuring the covered services.

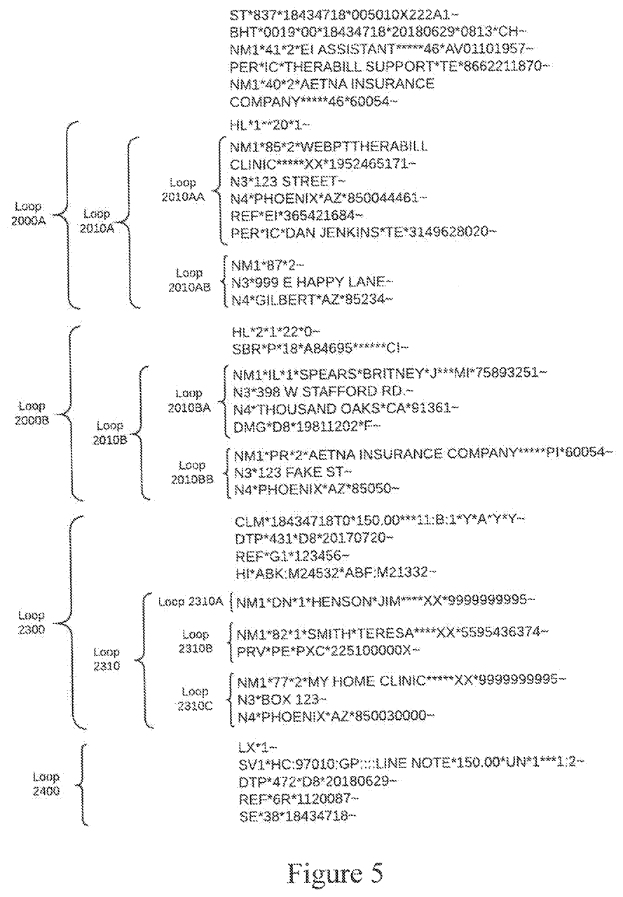

FIG. 5 illustrates an exemplary EDI 837 file. Each block or section of an EDI file is called a Loop. Each loop contains several different Segments, which are comprised of Elements and Sub-Elements. Although Loops are the biggest component in an EDI, they are often the hardest to distinguish. They will typically begin with an HL or NM1 Segment. While there are several different Loops, they can be broken into 5 main sections:
2000A=Billing Provider
2000B=Subscriber
2000C=Client (Only present if different from Subscriber)
2300=Claim Information
2400=Service Line Information

Segments are separated onto their own line and each line ends with a segment separator that is a tilde (˜). Additionally, every segment begins with a Segment Identifier Code. Common codes include:
PRV=Provider
SBR=Subscriber
HL=Hierarchy
NM1=Name
N3=Street Address
N4=City, State, and ZIP
DTP=Date
DMG=Demographic
REF=Reference
CLM=Claim
LX=Line
SV1=Service

Within each Segment are several asterisks (*) which serve as Element Separators. Additionally, Sub-Elements are separated using a colon (:). Multiple asterisks or colons appearing side-by-side indicates that the Element or Sub-Element is empty. As with Segments, there are also several Element Identifier Codes that are commonly employed, such as:
41=Claim Creator (Hardcoded to EI Assistant)
40=Claim Receiver
85=Billing Provider
82=Rendering Provider
DN=Referring Provider
IC=Information Contact
77=Service Location
472=Date of Service
SY=Social Security Number
EI=Tax ID (EIN)
XX=NPI
Y4=Claim Casualty Number
HC=Standard CPT Code
ABK=Principal Diagnosis
ABF=Diagnosis

As further shown in FIG. 1, after receiving the medical claim data 101, the insurance payer computerized system 30 may transmit medical claim remittance data 102 back to the provider computerized system 20. In one embodiment, the medical claim remittance data 102 may be standardized medical EDI 835 files.

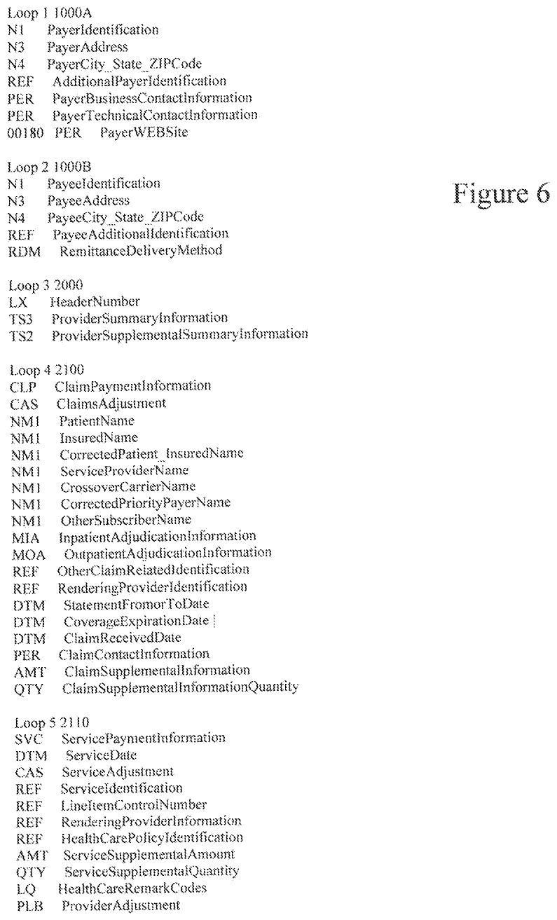

FIG. 6 illustrates the fields of an exemplary EDI 835 file. As shown, the EDI 835 file includes 5 Loops, each having the elements shown in FIG. 6. Medical claim remittance data files are typically generated by insurers and transmitted to providers to communicate either non-payment, or reimbursement amount of claim(s). Remittances in remittance EDI 835 files arrive asynchronously although always after related claims in EDI 837 files. Remittances in EDI 835 files may cover multiple separate claims, and claims in EDI 837 files may be partially paid over multiple remittances in different remittance EDI 835 files.

Returning to FIG. 1, the provider computerized system 20 may also transmit the medical claim data 101 and medical remittance data 102 (once received from the insurance payer computerized system 30) to the computerized medical claims valuation and collateralization management platform 100. As further described below, the platform 100 receives and stores instructions from the lender computerized system(s) 50 that allow lenders to configure and or set the terms of their loans to providers. The platform 100 also receives and stores instructions from the provider computerized system 20 with regard to when to initiate cash advances.

The platform 100 may automatically generate as output advance instruction data 405 that may be transmitted to the lender computerized system 50. In one embodiment, the advance instruction data 405 may instruct the lender computerized system 50 to transfer an amount of cash indicated by the cash advance data 401 to the account of the provider at the provider bank computerized system 40.

In one embodiment, the advance instructions data 405 may also include documents to convey an ownership interest to the lender. The platform 100 also generates payment routing instructions data 404 and transmits it to the provider bank computerized system 40. The payment routing instructions data 404 may direct an advance repayment 403 from the account of the provider at the provider bank 40 to the lender 50.

On one embodiment, the lender and the provider bank may be separate entities employing different computerized systems, but in another embodiment, they may be the same entity and may employ the same computerized system.

In one embodiment, as further described below, the computerized medical claims valuation and collateralization management platform 100 generates a predictive valuation model for a provider's unpaid medical claim data 101. The predictive valuation model may then be applied to newly received and unpaid medical claim data. The valuation of the unpaid claims may be used as collateral for loans advanced by the lender.

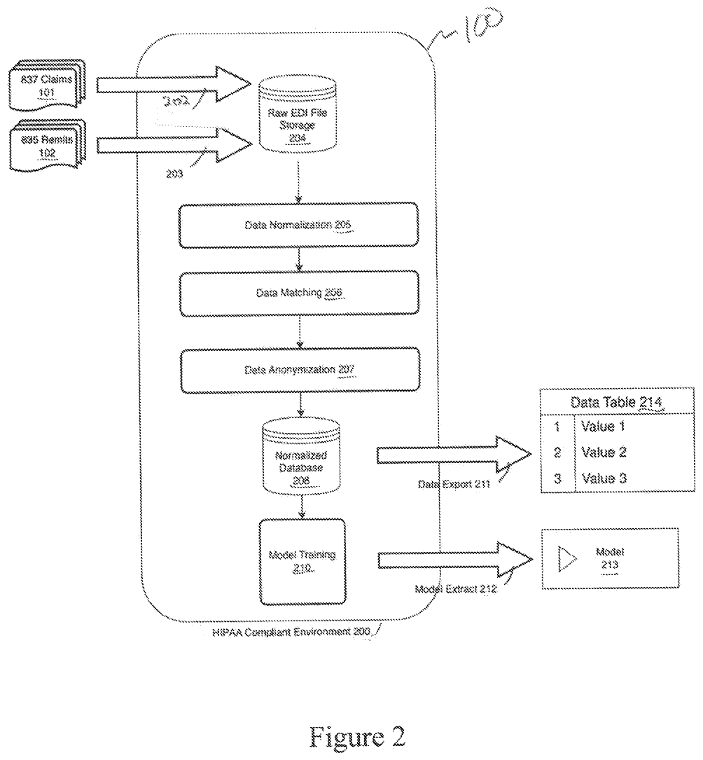

FIG. 2 illustrates the computerized medical claims valuation and collateralization management platform 100 determining the predictive claim valuation model according to an embodiment of the present invention. As shown in FIG. 2, the platform 100 receives the medical claim data 101 and medical claim remittance data 102. In one embodiment, the medical claim data 101 and medical claim remittance data 102 represent historical claim and remittance data for a specific provider using the provider computerized system 20.

In one embodiment, the medical claim data 101 and/or medical claim remittance data 102 may be transmitted to the platform 100 using any of a number of commercially available protocols. One embodiment of a transfer protocol that may be used by the platform is a Secure File Transfer Protocol (SFTP) interface 202. Claim remittance files 102 may be transmitted to the platform 100 by either a separate interface 203, or by the same interface. When received from the interfaces 202, 203, the medical claim data 101 and medical claim remittance data 102 are then stored in the raw EDI file storage 204.

In one embodiment, the determining the predictive valuation model is performed within a HIPAA-compliant computing environment 200. A HIPAA-compliant computing environment 200 is a secure, segregated storage and computation environment that allows for processing of patient-protected data, including PHI. The HIPAA-compliant computing environment 200 may include one or more of the following:

### Administrative Safeguards

Security Management Process. The HIPAA-compliant computing environment 200 may identify and analyze potential risks to electronic PHI (e-PHI), and it may implement security measures that reduce risks and vulnerabilities to a reasonable and appropriate level.

Security Personnel. The HIPAA-compliant computing environment 200 may designate a security official who is responsible for developing and implementing its security policies and procedures.

Information Access Management. The HIPAA-compliant computing environment 200 may implement policies and procedures for authorizing access to e-PHI only when such access is appropriate based on the user or recipient's role (role-based access).

Workforce Training and Management. The HIPAA-compliant computing environment 200 may provide for appropriate authorization and supervision of workforce members who work with e-PHI.

Evaluation. The HIPAA-compliant computing environment 200 may perform a periodic assessment of how well its security policies and procedures meet the requirements of the Security Rule.

### Physical Safeguards

Facility Access and Control. The HIPAA-compliant computing environment 200 may limit physical access to its facilities while ensuring that authorized access is allowed.

Workstation and Device Security. The HIPAA-compliant computing environment 200 may implement policies and procedures to specify proper use of and access to workstations and electronic media. The HIPAA-compliant computing environment 200 may have in place policies and procedures regarding the transfer, removal, disposal, and re-use of electronic media, to ensure appropriate protection of e-PHI.

### Technical Safeguards

Access Control. The HIPAA-compliant computing environment 200 may implement technical policies and procedures that allow only authorized persons to access e-PHI.

Audit Controls. The HIPAA-compliant computing environment 200 may implement hardware, software, and/or procedural mechanisms to record and examine access and other activity in information systems that contain or use e-PHI.

Integrity Controls. The HIPAA-compliant computing environment 200 may implement policies and procedures to ensure that e-PHI is not improperly altered or destroyed. Electronic measures must be put in place to confirm that e-PHI has not been improperly altered or destroyed.

Transmission Security. The HIPAA-compliant computing environment 200 may implement technical security measures that guard against unauthorized access to e-PHI that is being transmitted over an electronic network.

Returning to the operation of the platform 100 as shown in FIG. 2, upon receipt of new medical claim data 101 and/or medical claim remittance data 102 in the data storage 204, the individual claim and remittance data are passed to the data normalization system 205 where the data are extracted and normalized. In one embodiment, the data entries of the medical claim data 101 and/or medical claim remittance data 102 are organized so that they appear similar across all available fields and records, making information easier to find, group and analyze.

Next, the normalized data is passed to the data matching system 206 where the medical claim data 101 are matched with corresponding medical claim remittance data 102. In one embodiment, specific claims are matched to specific remittances because remittances contain specific payment information (as identified above) such as amount and payment date that claims do not have, and claims contain more detailed information (as identified above) than typically provided in remittances.

Once claims and remittances are matched by the data matching system 206, the claims and remittances are passed to the data anonymization system 207 where they are anonymized. The anonymization system 207 takes consolidated claims and remittances from 206, removes any PII that is not used to predict payments, and one-way hashes (for example using a cryptographic hash such as SHA-256) any individual data fields that contain PII that is used to predict payments. The output of the anonymization system 207 is a data set of claims that does not contain HIPAA-protected data, which is stored in normalized database 208.

Normalized database 208 serves two downstream functions. The first is as a store of non-HIPAA-protected data that may be exported into a data table 214 using a variety of data export systems 211 to non-HIPAA-compliant endpoints. One embodiment of an export protocol system 211 currently used by the platform is CSV format.

The second function served by the normalized database 208 is to provide training, validation, and testing data to the model training system 210. The model training system includes a machine learning model that comprises a variety of predictive algorithms tuned to most accurately predict one or more target variables. One example of a set of variables predicted by an embodiment of model training system 210 is 1. denial probability, 2. expected payment amount, and 3. expected time to payment. Importantly, the model data 213 generated by model training system 210 uses non-HIPAA-protected data to create non-HIPAA-protected predictions. As a result, model data 213 can be exported by a variety of protocol systems 212 to be used to either create new predictions or confirm the predictions made previously.

In one embodiment, a denial probability prediction may be determined by determining a provider-specific denial probability based on EDI claim information broken down by one or more of individual service, individual diagnosis, insurance payer and insurance coverage. Additionally, an expected payment amount prediction may be determined by determining a provider-specific payment amount average based on EDI claim information broken down by one or more of individual service, individual diagnosis, insurance payer and insurance coverage. Finally, an expected time to payment prediction may be determined by determining a provider-specific payment amount average based on EDI claim information broken down by one or more of individual service, individual diagnosis, insurance payer and insurance coverage.

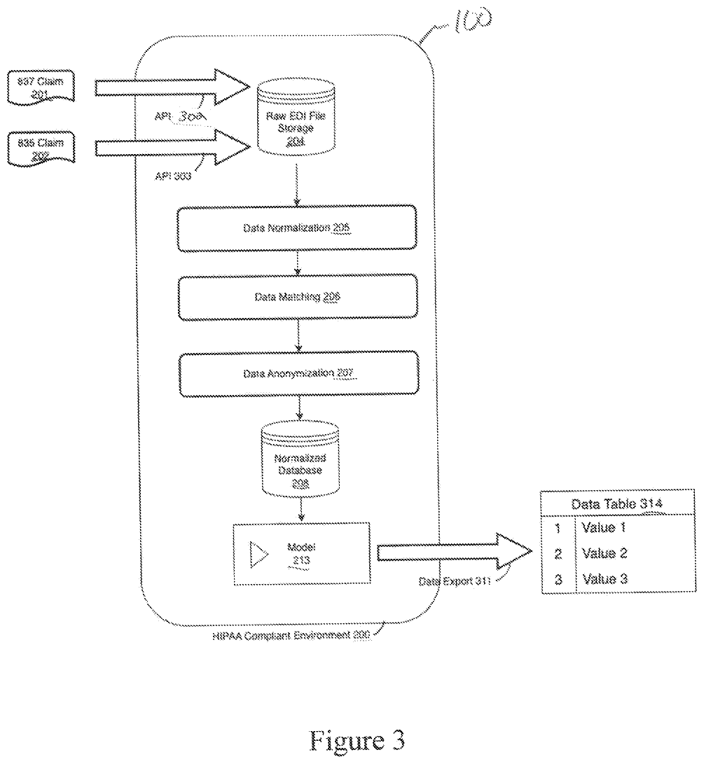

FIG. 3 illustrates the computerized medical claims valuation and collateralization management platform 100 applying the predictive claim valuation model to newly received claim information according to an embodiment of the present invention. As shown in FIG. 3, the platform 100 receives the medical claim data 201 and medical claim remittance data 202 from the provider computerized system 20 and stores them in the raw EDI file storage 204.

The medical claim data 201 and medical claim remittance data 202 may be transmitted using one or more Application Programming Interfaces (APIs) 302, 303. The protocol system used in API 303 may be the same or different than interfaces 202, 203. However, when the medical claim data 201 and/or medical claim remittance data 202 are received by APIs 302, 303 the files automatically pass through the remaining systems as shown in FIG. 3.

In one embodiment, files transmitted using APIs 302, 303 are stored in an instance of raw EDI file storage 204 that may or may not be the same volume as that of the raw EDI file storage of FIG. 2. Next the medical claim data 201 and/or medical claim remittance data 202 proceed through the data normalization system 205, data matching system 206, and data anonymization system 207 as discussed above in FIG. 2.

The output of the data anonymization system 207 is non-HIPAA-protected data that may be stored in the normalized database 206. From the normalized database 206, the non-HIPAA-protected data may be passed to the predictive model system, which applies the predictive model to generated values 1, 2, and 3 representing: 1. denial probability, 2. expected payment amount, and 3. expected time to payment for the newly received claim data. The output of the predictive model system 213 may then be exported into a data table 314 using any of a variety of data export systems 311 to non-HIPAA-compliant endpoints. One embodiment of a data export system 311 that may be used by the platform is CSV format.

Because the input to the predictive model system 213 is anonymized claim data, the predictions of medical claims performance contained in data table 314 may be independently generated in a non-HIPAA-compliant environment using the non-HIPAA-protected information contained in normalized database 206. This allows non-HIPAA-compliant third parties who possess a specific embodiment of the trained predictive model system 213 to have access to the data in order to independently verify the generated values.

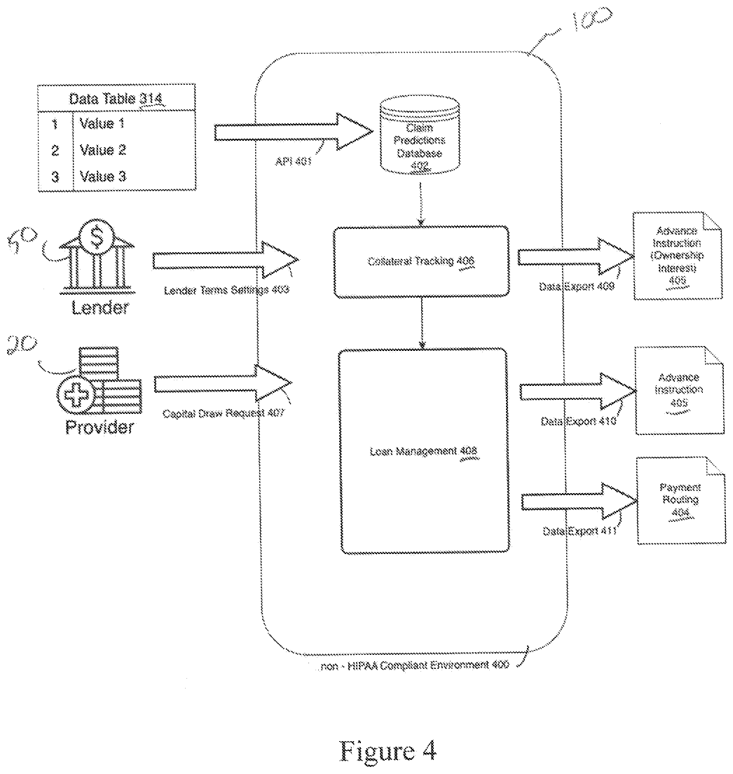

FIG. 4 illustrates the computerized medical claims valuation and collateralization management platform 100 performing automated valuation and capital management according to an embodiment of the present invention. As shown in FIG. 4, the platform 100 received the data table 314 through the API 401. The platform also received the lender term setting data 403 from the lender computerized system 50 and the capital draw request data 407 from the provider computerized system 20.

As discussed above, the embodiment shown in FIG. 4 may be a non-HIPAA compliant computing environment because the values contained in the data table 314 have been derived using anonymized information. Thus, in one embodiment, the predictions of medical claims performance stored in data table 314 may be used to value unpaid medical claims for use as collateral to secure cash advances from lenders to providers.

The protocol system used in API 401 may be the same or different than the APIs 302, 303 or interfaces 202, 203 shown in FIG. 2 or 3. The data from the data table 314 may be used to populate a claims prediction database 402. From the claims prediction database 402, claims can be extracted to collateralize any potential loans from the lender in the collateral tracking system 406. The collateral tracking system 406 tracks the predicted repayment amount of all EDI 837 claims imported in live claim files 201, but not yet settled by a final remittance 202. The collateral tracking system 406 is flexible and may be configured to support the needs of the lender by using the lender term settings data 403. Some specific examples of lender term setting data 403 that may be used include maximum per-claim value, initial overcollateralization, and maximum loan amount.

In one embodiment, the lender term settings data 403 may be stored at the platform 100 and may be used as control inputs for the collateral tracking system 406 and/or loan management system 408. In one embodiment, the lender term settings data 403 may include a maximum per-claim threshold value so that for the specific lender setting the threshold, the platform 100 will not accept individual claims above the threshold value as collateral. In one embodiment, the lender term settings data 403 may include a maximum per-provider threshold value so that for the specific lender setting the threshold, the platform 100 will not loan more than the threshold to a specified provider. In one embodiment, the lender term settings data 403 may include an initial overcollateralization threshold value so that for any claim, the platform will lend only up to a threshold value of the predicted value of the claim. For example, in one embodiment a lender may set its overcollateralization threshold value to 85% so that the lender will not lend more than 85% of the predicted value of the claim.

As new updates to claims 201 or remittances 202 arrive to the data table 314, the net collateral value maintained by the collateral tracking system 406 is updated. Additionally, the collateral tracking system 406 may create advance instruction documents supporting ownership interest 405 by the lender. These ownership interest 405 documents may be transmitted using a data export system 409. One example of a data export system 409 used by the system is email.

Additionally, the net collateral value maintained by the collateral tracking system 406 is utilized in the loan management system 408. The loan management system 408 stores the amount currently borrowed using the platform 100 for each provider and the amount of collateral the collateral tracking system 406 reports as available. If there is sufficient loan capacity available (if the current amount advanced as a loan to a specific provider is less than the total available loan amount set by the lender for that provider or if a current credit line set by the lender for that provider is able to be drawn from before reaching the maximum), a provider may submit a capital draw request data 407.

When permitted, the loan management system 408 receives capital draw request data 407 and automatically generates advance instruction data 405 that may be transmitted to the lender computing system 50 using a data export API 410. A specific example of a data export API 410 is a connection to a lender's payment processing infrastructure. As part of a valid capital draw request, a separate advance instruction 405 may be automatically created to reflect an agreed-upon origination fee to the platform provider.

In addition to generating advance instruction data 405 in response to the receipt of capital draw request data 407, the loan management system tracks and records remittance payments indicated by remittances 202. These remittances 202 reflect payments from insurers to the provider's bank account. For payments of claims 201 submitted to the system, the provider must allow payment routing instructions data 404 to be automatically processed by their bank. Payment routing instructions data 404 are automatically created by the loan management system 408 when remittances 202 arrive and the provider entitled to the remittances has either outstanding interest to be repaid, or there is a collateral deficit reported by the collateral tracking system 406. When this happens, the loan management system 408 calculates the amount of remittance needed to repay the existing loan outstanding and/or bring the outstanding loan balance to the amount required by the lender term settings data 403. The payment routing instructions data 404 may then be used to automatically direct portions of the incoming payment described in remittance 202 to the lender computerized system 50. Additionally, the loan management system may automatically issue payment routing instructions data 404 to direct an agreed-upon servicing fee to the platform provider. Payment routing instructions data 404 may be transmitted to the lender using a data export API 411. A specific example of a data export API 411 is a connection to a lender's payment processing infrastructure. There is no requirement that APIs 410 and 411 be distinct.

Thus, one or more embodiments of the present system provides a software platform for valuing medical claims and connecting healthcare providers to lenders. The platform uses advanced algorithms and a predictive model to score medical claims based on their predicted value. The platform also provides lenders the ability to access non-HIPAA-protected data in order to offer financing for providers' medical claims. The platform also allows healthcare providers to track the status of their claims and financing requests, and lenders can manage their portfolios and monitor the performance of their investments.

As described above, the computerized medical claims valuation and collateralization management platform 100 is a software platform that provides an automated, streamlined, and efficient solution for evaluating medical claims and financing them. It represents a significant advance over existing systems and has the potential to transform the healthcare industry.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

1. An automated system for secure, anonymized medical claim data processing and collateralization management.
